(19) United States
(12) Patent Application Publication
(10) Pub. No.: US 2019/0270380 A1
(43) Pub. Date: Sep. 5, 2019

(54) Tandem Axle System

(71) Applicant: Dana Heavy Vehicle Systems Group, LLC, Maumee, OH (US)

(72) Inventors: Mark A. Davis, Kalamzoo, MI (US); Steven G. Slesinski, Ann Arbor, MI (US)

(21) Appl. No.: 16/024,192

(22) Filed: Jun. 29, 2018

Related U.S. Application Data
(60) Provisional application No. 62/527,575, filed on Jun. 30, 2017.

(51) Int. Cl. B60K 17/36; B60B 35/12; F16H 48/05; F16H 48/08

(52) U.S. Cl. CPC B60K 17/36; B60B 35/122; B60B 35/127; F16H 48/08; F16H 48/05

(57) ABSTRACT

Provided herein is a tandem axle system including a top-mount forward axle assembly, a rear axle assembly and an intermediate drive shaft assembly.

### RELATED APPLICATION

The present application claims priority to U.S. Provisional patent application Ser. No. 62/557,575, filed on Jun. 30, 2017, which is incorporated herein by reference in its entirety.

### BACKGROUND

A conventional tandem axle vehicle utilizes forward axle and rear axle assemblies and an intermediate drive shaft assembly connected to the two axle assemblies. Typically, at least one of the axles is driven and, in some cases, both axles are driven. Tandem axle assemblies for truck tractors are typically provided with either a single drive axle and a single tag axle (referred to as a 6×2 arrangement) or with dual drive axles (referred to as a 6×4 arrangement). A full time 6×4 driveline can include an inter-axle differential lock and optional wheel differential lock(s).

The forward and rear axle assemblies each include a pair of axle half shafts extending therefrom on which one or more wheels of a vehicle are mounted. Each of the forward and rear axle assemblies further includes a differential gear set that allows the wheels on each axle assembly to rotate at different speeds and are drivingly connected to an intermediate drive shaft assembly.

The intermediate drive shaft assembly includes an output yoke and an input yoke that exit and enter, respectively, the forward and rear axle assemblies at different working angles. This difference in working angles results in a “broken back” arrangement for the intermediate drive shaft disposed between the two yokes and subjects the universal joints coupling the intermediate drive shaft to the yokes to relatively large amounts of vibration and torsional stress creating inefficiencies.

Therefore, there is a need for a tandem axle system with improved efficiency to overcome the deficiencies described above.

### SUMMARY

Provided herein is a tandem axle system including a top-mount forward axle assembly, a rear axle assembly and an intermediate drive shaft assembly drivingly connecting the rear axle assembly and the forward axle assembly.

### BRIEF DESCRIPTION OF THE DRAWINGS

The above, as well as other advantages of the present embodiments, will become readily apparent to those skilled in the art from the following detailed description when considered in the light of the accompanying drawings in which:

FIG. 1 is a schematic plan view of a vehicle having a tandem axle system.

FIG. 2 is a cross-sectional view of one embodiment of a forward axle assembly of the tandem axle system.

FIG. 3 is a side view of another preferred embodiment of a tandem axle system;

FIG. 4 is a side view of another preferred embodiment of a tandem axle system;

FIG. 5 is a side view of another preferred embodiment of a tandem axle system;

FIG. 6 is a perspective view of rear axle assembly with a hypoid gearset.

### DETAILED DESCRIPTION OF THE PREFERRED EMBODIMENTS

It is to be understood that the embodiments may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless expressly stated otherwise.

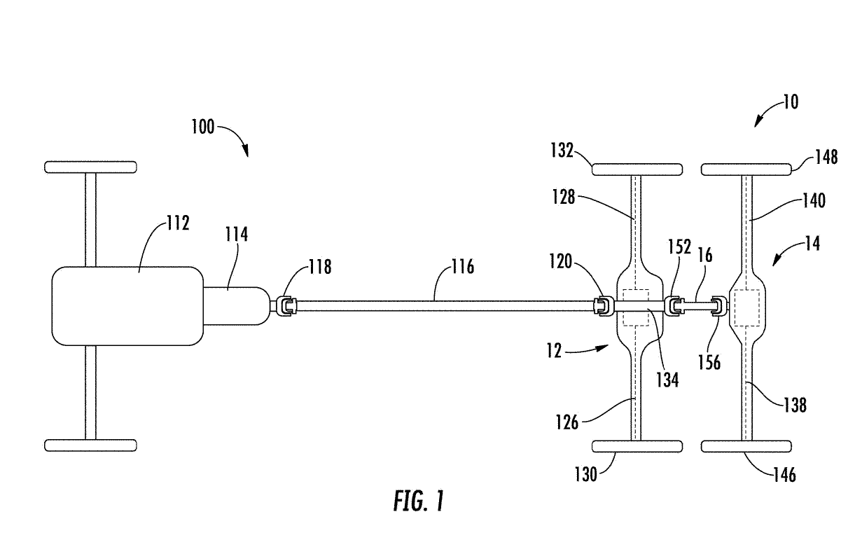

Referring now to FIG. 1, a vehicle 100 having an engine 112 drivingly connected to a transmission 114 is depicted. A shaft 116 is connected to an output portion of the transmission 114, such as by a single cardan universal joint yoke 118, as known to those skilled in the art, and is drivingly connected to an input, such as a single cardan U-joint yoke, of a forward axle assembly 12 of a tandem axle system 10.

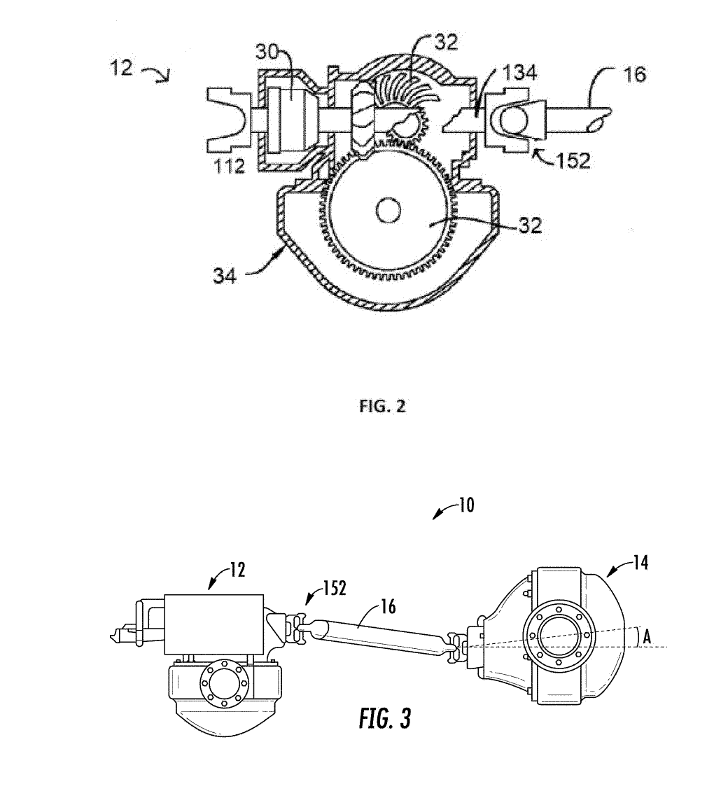

The tandem axle system 10 includes the forward axle assembly 12, a rear axle assembly 14 and an intermediate drive shaft assembly 16 as depicted in FIGS. 2-4.

In some embodiments, the tandem axle system 10 is particularly adapted for use in heavy trucks including Class 8 tractor. It should be understood, however, that the present embodiments are not limited to use in heavy trucks and may be used in a wide variety of motor vehicles.

As described in more detail below, drive is transmitted from the engine 112 or primary power source to the yoke 120 to a first forward drive axle 126 and a second forward drive axle 128 of the forward axle assembly 12. The first forward drive axle 126 provides drive to at least one wheel 130 and the second forward drive axle 128 provides drive to at least one wheel 132 as known to those skilled in the art.

A through shaft 134 extends through the forward axle assembly 12 and is drivingly connected to the intermediate drive shaft assembly 16. The intermediate drive shaft assembly 16 connects the forward drive axles 126, 128 with a first rear drive axle 138 and a second rear drive axle 140.

More specifically, the intermediate drive shaft assembly 16 transmits drive from a single cardan U-joint yoke 152 output to an input, such as a single cardan U-joint yoke 156, as known to those skilled in the art, for the rear drive axles 138, 140. The rear drive axles 138, 140 are part of the rear axle assembly 14. The first rear drive axle 138 provides drive to at least one wheel 146 and the second rear drive axle 140 provides drive to at least one wheel 148 and associated, as known to those skilled in the art

FIGS. 2-5 depict one embodiment of the forward axle assembly; however, it can be appreciate that other known efficient forward axle assemblies can be used.

As depicted in FIG. 2, in some embodiments, the forward axle assembly 12 is a top-mount assembly including a power divider lock out 30 and a differential gear assembly 32 positioned within a housing 34. Tapered roller bearings support the differential housing for rotation on opposing sides thereof.

A bevel pinion gear meshes with a ring gear of the differential gear assembly 32. The assembly 12 further includes a stub shaft or through shaft connected to the intermediate drive shaft assembly 16 via the coupling.

In some embodiments, the stub shaft is supported for rotation by a single roller bearing arrangement mounted at the forward end of the shaft and by a pair of tapered roller bearings mounted at the rear end of the shaft.

Referring back to FIGS. 3-5, the forward axle assembly 12 is connected via the intermediate drive shaft assembly 16 to the rear axle assembly 14, 114, 214. As can be appreciated from FIGS. 3-5, the intermediate drive shaft 16 angles downward at an angle from the output of the forward axle assembly 12 to the input of the rear axle assembly 14, 114, 214 depending on the architecture of the rear axle assembly 14, 114, 214.

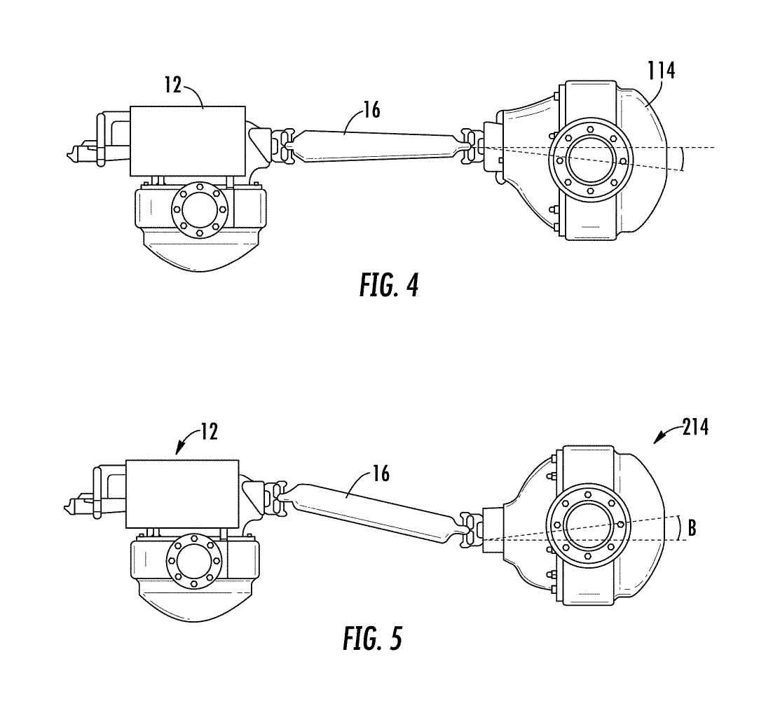

In some embodiments, as depicted in FIGS. 3 and 4, the rear axle assembly 14, 114 includes a rear hypoid gear set including a rear pinion gear drivingly connected to a drive side of a rear portion of a rear ring gear.

In some embodiments, as depicted in FIG. 3, the rear axle assembly 14 includes a hypoid gear set and the shaft of the intermediate driveshaft assembly angles downward at a working angle A from the output yoke 152 of the forward axle assembly 12 to the input yoke 156 of the rear axle assembly 14.

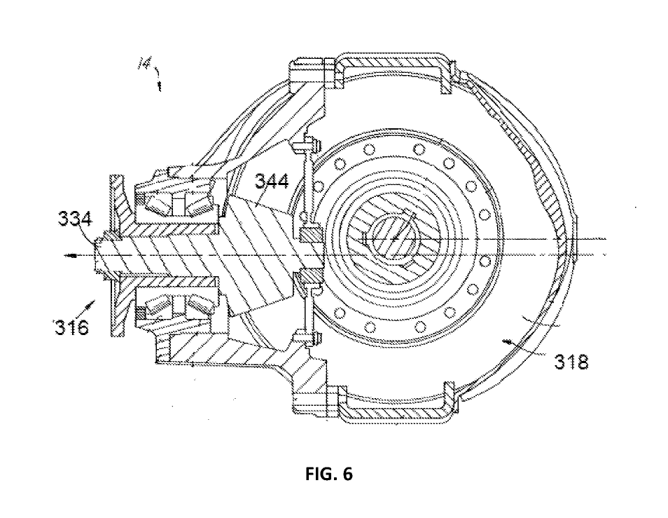

In some embodiments, the rear axle assembly 14 is as depicted in FIG. 6 and described in U.S. Pat. No. 6,514,169 which is incorporated by reference herein. In some embodiments, the rear axle assembly 14 includes a housing 314, a pinion shaft assembly 316 and a differential gear assembly 318. The differential gear assembly 318 that includes a pinion gear 344, a ring gear 346, and a conventional bevel gear set (not shown) disposed within a differential carrier 348. Pinion gear 344 is provided to transfer torque from intermediate drive shaft assembly 16 to ring gear 346. The pinion gear 344 includes a hypoid gear. Gear 344 is disposed about a shaft 334 and may be integral therewith as shown in the illustrated embodiment or may be mounted thereto using a conventional spline connection or in other ways customary in the art. The ring gear 346 may also include a hypoid gear and is affixed to a carrier or may be integral therewith.

In some embodiments, as depicted in FIG. 4, the rear axle assembly 114 includes an above-hypoid gear set attachment. In this embodiment, the intermediate drive shaft assembly 16 is substantially “parallel” to the output yoke 152 and input yoke 156, entering the forward 12 and rear axle 114 assemblies at the same angle. Thus, the yokes 152, 156 are not subject to the same degree of vibration and torsional stress as if there is a working angle.

In some embodiments, as depicted in FIG. 5, the rear axle assembly 214 includes a spiral bevel gear set resulting in the shaft of the intermediate driveshaft assembly angling downward at a working angle B from the output yoke 152 of the forward axle assembly 12 to the input yoke 156 of the rear axle assembly 214.

One embodiment of a rear axle assembly 114 with a spiral gear set is described in U.S. Pat. No. 8,911,321 and incorporated herein by reference. In one embodiment, the rear axle assembly 114 includes an input shaft rotatingly mounted within the housing on at least two bearings. A spiral bevel pinion is located on the end of the input shaft. The spiral bevel pinion is co-axial with the input shaft. The spiral bevel pinion is engaged with a rear ring gear. The rear ring gear is connected to a rear differential. The rear differential divides the rotational drive provided by the ring gear between the rear axle half shafts.

It can be appreciated that the spiral bevel pinion reduces the overall height required connection of the rear axle assembly 14 to the interaxle drive shaft assembly 16, as compared to a hypoid bevel pinion arrangement, as depicted in FIGS. 3 and 4. However, the working angle B is greater than the working angle A which may result in higher degrees of vibration and torsional stress comparatively.

In some embodiments, the tandem axle system 10 includes a single gear mesh configuration from the engine to the wheels, such as that as included in the AdvanTEK® tandem drive axle assembly, allowing the tandem axle system 10 to operate as a 6×4 with a traditional starting ratio that delivers the optimal tractive effort needed.

In some embodiments, the system 10 includes an electronic control unit (ECU) which coordinates with engine and transmission ECUs to disconnect the inter-axle shaft 134 from the power divider, allowing the tandem axle system 10 to operate in a more efficient 6×2 mode. At the same time, the ECU shifts the forward axle assembly 12 to a faster ratio that enables the engine speed to decrease to as low as 900 rpm for highway cruise operation.

Additionally, in some embodiments, the tandem axle system 10 can include additional features such that the tandem axle system 10 operates at an increased efficiency including a synchronizer system, a lubrication system and disconnect clutches as described in U.S. Pat. Nos. 6,514,169 and 8,911,321 and incorporated herein by reference.

Further, in some embodiments, the tandem axle system 10 includes a lubrication flow system such as a power lubricant flow restrictor as described in U.S. Pat. No. 7,258,641 and incorporated herein by reference, for example.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practice.

What is claimed:

1. A tandem axle system comprising:
a top-mount forward axle assembly;
a rear axle assembly; and
an intermediate drive shaft assembly drivingly connecting the rear axle assembly and the forward axle assembly.
